(19) United States
(12) Patent Application Publication
(10) Pub. No.: US 2009/0242369 A1
(43) Pub. Date: Oct. 1, 2009

(54) KEYBOARD ASSEMBLY AND ELECTRONIC DEVICE USING THE SAME

(75) Inventors: ZHENG SHI, Shenzhen City (CN); CHIH-CHIANG CHANG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/191,396

(22) Filed: Aug. 14, 2008

(30) Foreign Application Priority Data
Mar. 26, 2008 (CN) 200810300725.7

(51) Int. Cl. H01H 9/00

(52) U.S. Cl. 200/314; 200/310

(57) ABSTRACT

A keyboard assembly (30) includes a keyboard (31) having two opposite surfaces and an light-penetrating board (35). The keyboard (31) is configured for obstructing light from transmittal therethrough and is made of opaque material. One surface of the keyboard (31) defines several keypads (312) thereon. Each keypad (31) defines some character holes (315) therethrough that allow light to pass through the character through hole. The light-penetrating board (35) is formed on the other surface of the keyboard (31) with double-color injecting molding. The invention also includes an electronic device using the keyboard assembly (30).

### BACKGROUND OF THE INVENTION

1. Technical Field

The present invention generally relates to keyboard assemblies and portable electronic devices, such as mobile phones, personal digital assistants (PDAs), etc., using the keyboard assembly.

2. Discussion of the Related Art

With the developments of wireless communication and information processing technologies, portable electronic devices such as mobile phones and personal digital assistants (PDAs) are now in widespread use, and consumers may now enjoy the full convenience of high products almost anytime and anywhere. Typical portable electronic devices generally include a keyboard assembly to fulfill the operation of the portable electronic device, such as input or output information, answer or dial the telephone number, etc.

Referring to FIG. 4, a typical keyboard assembly 60 includes a main body 61 and a light obstructing layer 65. The main body 61 is substantially rectangular and made of transparent and flexible material such as polyethylene terephthalate (PET), by injection molding. The main body 61 has several keys 63 protruding therefrom. The light obstructing layer 65 is an opaque paint layer painted on an outer surface of the main body 61, except in key character areas 68 defined on the outer surface of the main body 61. When the electronic device is used at night, the user can recognize the key character information by backlight passing through the key character areas 68. However, continually pressing the keys 63 and continually touching the electronic device during use can scrape the paint off of the light obstructing layer 65. This will adversely affect the appearance of the electronic device and light will be leaked from the light obstructing layer 65. In addition, the required painting step during the manufacturing process complicates the manufacturing process and makes product quality hard to control. Therefore, manufacturing costs of the keyboard assembly 60 increase.

Therefore, there is room for improvement within the art.

### BRIEF DESCRIPTION OF THE DRAWING

Many aspects of the present keyboard assembly and portable electronic device using the keyboard assembly can be better understood with reference to the following drawings. The components in the drawings are not necessarily drawn to scale, the emphasis instead being placed upon clearly illustrating the principles of the present keyboard assembly and portable electronic device using the keyboard assembly. Moreover, in the drawings, like reference numerals designate corresponding parts throughout the several views.

FIG. 1 shows a schematic, perspective view of a portable electronic device using the keyboard assembly, according to the exemplary embodiment.

FIG. 2 shows a schematic, perspective view of a keyboard assembly of FIG. 1.

FIG. 3 shows a disassembled view of the keyboard assembly of FIG. 2.

FIG. 4 shows a schematic, perspective view of a typical keyboard assembly.

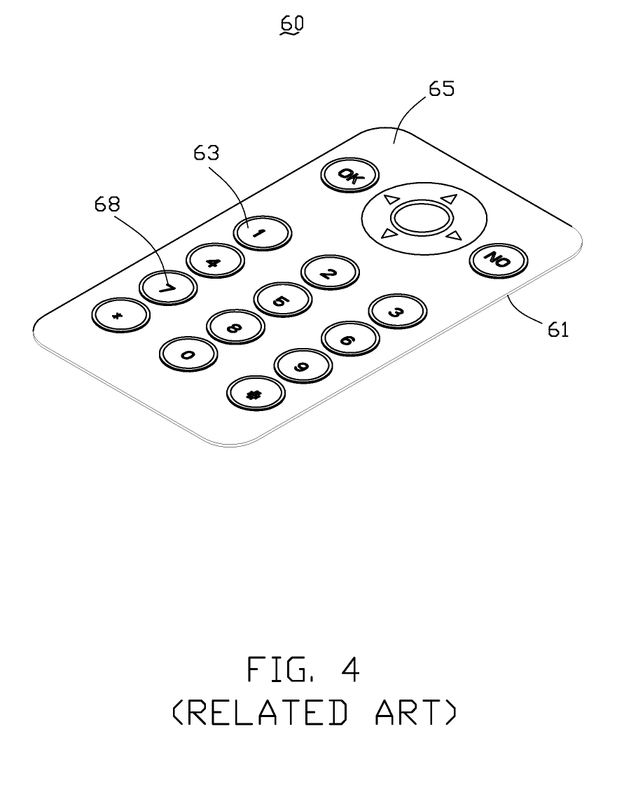

### DETAILED DESCRIPTION OF THE EMBODIMENT

The present invention discloses a keyboard assembly which is suitable for a portable electronic device, such as mobile phone, personal digital assistant (PDA), and the like. The present invention also discloses a portable electronic device using the keyboard assembly.

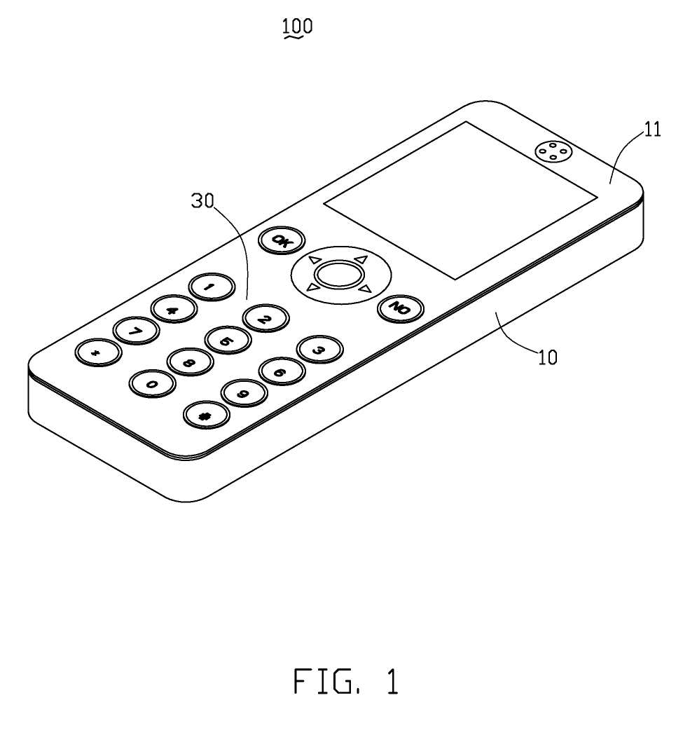

Referring now to FIG. 1, a portable electronic device 100 according to an exemplary embodiment includes a main body 10 and a keyboard assembly 30. The main body 10 is substantially rectangular, and has a front panel 11 configured for showing information and providing an operating unit, such as the keyboard assembly 30, for users. In the present exemplary embodiment, the keyboard assembly 30 fulfills the input/output operation of the portable electronic device 100.

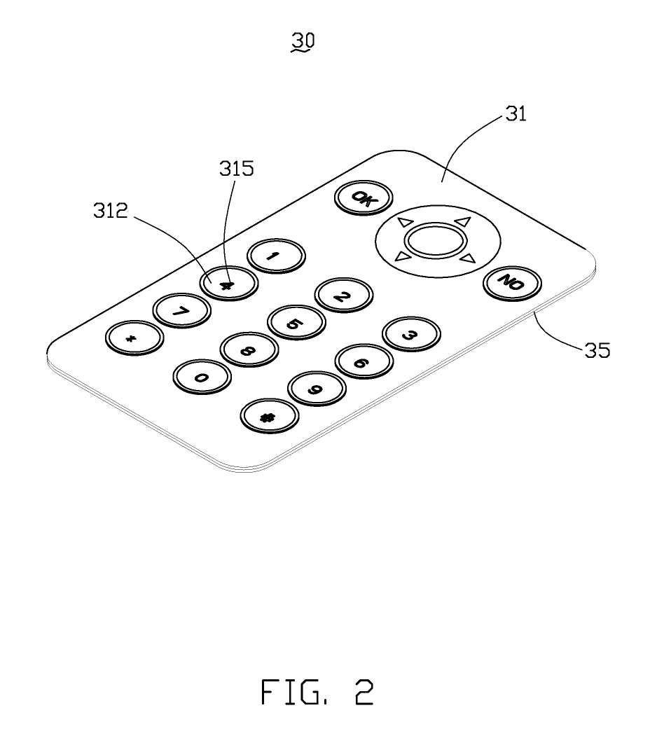

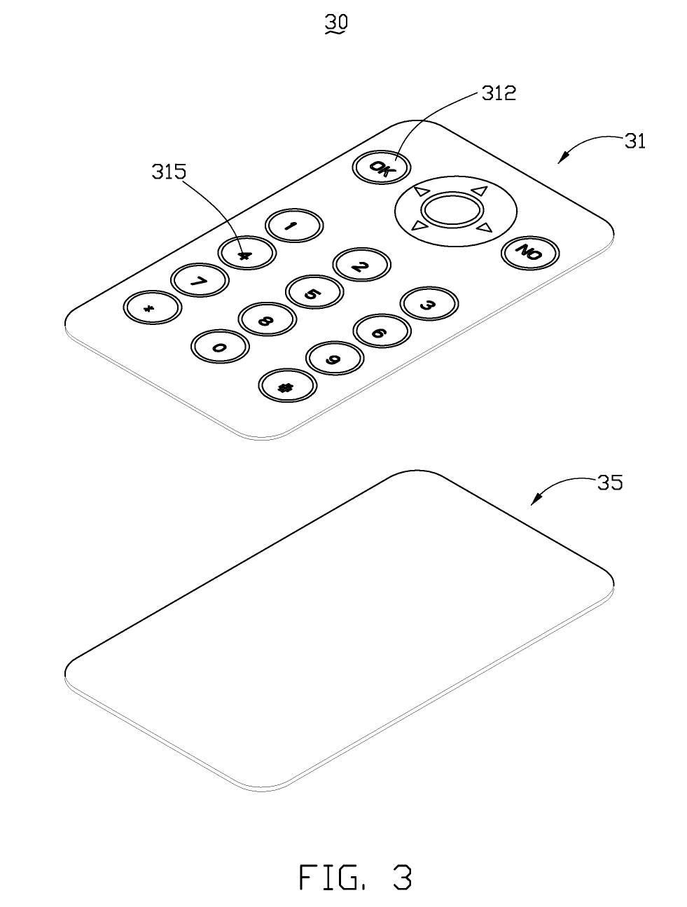

Also referring to FIG. 2 and FIG. 3, the keyboard assembly 30 is substantially rectangular, and includes a key board 31 and a light-penetrating board 35 integrally formed together. The light-penetrating board 35 and the key board 31 are integrally formed by double injecting molding. The key board 31 is configured for obstructing light from transmittal therethrough, and is made of opaque material such as rubber, thermoplastic polyurethane (TPU), polycarbonate (PC) or similar materials. The key board 31 is substantially rectangular and has several keypads 312 disposed on a surface thereof. Each keypad 312 defines a character through hole 315 that allows light to pass through the character through hole 315. The light-penetrating board 35 is substantially rectangular and attached on the other surface of the key board 31. The light-penetrating board 35 is made of transparent material such as polyethylene terephthalate (PET) material or other similar materials.

When the portable electronic device 100 is used at night or dark environment, a backlight (not shown) of the portable electronic device 100 projects light to the keyboard assembly 30. The light passes through the light-penetrating board 35 and the character through holes 315 of the keypads 312 to light the keypads 312 to facilitate user recognition of characters defined by the character through holes 315.

With this construction, the key board 31 is not easily peeled off or scratched, because, the key board 31 is produced by forming with the light-penetrating board 35 integratedly by double-color injecting molding. The keyboard assembly 30 avoids light leaking from the key board 31 because of the light-penetrating board 35, and improves the quality of the keyboard assembly 30. In addition, the keyboard assembly 30 is produced with double-color injecting molding which makes the process easy and decrease the producing cost of the keyboard assembly 30.

Finally, it is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A keyboard assembly for a portable electronic device, comprising:
a key board made of opaque material, including a plurality of keypads formed thereon, each keypad defining a character through hole; and
a light-penetrating board allowing light passing therethrough, the light-penetrating board being integrally formed with the key board by double injecting molding.

2. The keyboard assembly as claimed in claim 1, wherein the key board is made of rubber, thermoplastic polyurethane or polycarbonate material.

3. The keyboard assembly as claimed in claim 2, wherein the light-penetrating board is made of a transparent material.

4. The keyboard assembly as claimed in claim 3, wherein the transparent material comprises polyethylene terephthalate.

5. A portable electronic comprising:
a main body having an operating surface; and
a keyboard assembly disposed on the operating surface of the main body, the keyboard assembly comprising:
a key board made of opaque material, including a plurality of keypads formed thereon, each keypad defining a character through hole; and
a light-penetrating board allowing light passing therethrough, the light-penetrating board being integrally formed with the key board by double injecting molding.

6. The portable electronic as claimed in claim 5, wherein the key board is made of rubber, thermoplastic polyurethane or polycarbonate material.

7. The portable electronic as claimed in claim 6, wherein the light-penetrating board is made of a transparent material.

8. The portable electronic as claimed in claim 7, wherein the light-penetrating board is made of polyethylene terephthalate material.
